(19) United States
(12) Patent Application Publication
(10) Pub. No.: US 2011/0238767 A1
(43) Pub. Date: Sep. 29, 2011

(54) MESSAGE PROCESSING

(76) Inventor: John Paul Murphy, Edinburgh (GB)

(21) Appl. No.: 13/120,079

(22) PCT Filed: Sep. 24, 2009
(86) PCT No.: PCT/GB09/51248

§ 371 Date: Jun. 1, 2011

Related U.S. Application Data
(60) Provisional application No. 61/099,733, filed on Sep. 24, 2008.

(51) Int. Cl. G06F 15/16

(52) U.S. Cl. 709/206

(57) ABSTRACT

A message (such as email) processing system and method functions to process incoming messages. The message processing system has: a message receiver (16) that receives a message (14); an identifying component (18) that determines a sending or receiving user identity from the message; a content categoriser (20) component that determines a content category of the message; and a message delivery action component (26) that takes a delivery action based on the user identity and content category Delivery actions may include forwarding the message, permanently withholding the message, temporarily holding the message until a predetermined delivery time or time window and diverting the message to a predetermined forwarding address. The message delivery action component (26) may use a database (30) of policies that associate the user identity with a delivery rule applicable to a predetermined content category, to take the delivery action. In determining the content category of the message, the content categoriser component (26) may use a domain in the sending address or message body, with a domain database (22) comprising records of domains with associated predetermined content categories, or may examine a web page associated with the domain.

This invention relates to message processing, in particular receiving messages and forwarding them to recipients.

In the field of message processing, email filtering systems are used by organisations for the detection and elimination of threats. These threats include spam, phishing and malware. Once these threats have been removed from an inbound email stream then the email messages that remain are considered “good”, that is free from malicious intent, and are forwarded on for delivery to recipient users.

However, this “good” email, whilst already filtered of content deemed malicious or damaging, may be directed towards individuals for their own personal use and not for purposes reconcilable with the business of the organisation for which they work. The time spent reading, analysing and responding to such email detracts from the amount of time available to perform tasks that contribute to the delivery of the goods or services that the organisation exists to provide, and so may be considered a problem that ranks alongside the more traditional email-borne threats listed above.

According to a first aspect of the present invention there is provided a message processing system comprising:

a message receiver component that receives a message;

an identifying component that determines a user identity from the message;

a content categoriser component that determines a content category of the message; and

a message delivery action component that takes a delivery action based on the determined user identity and the determined content category.

Preferably, the message comprises an incoming message and the user identity comprises a recipient user identity.

Alternatively, the message comprises an outgoing message and the user identity comprises a sender user identity.

Preferably, the message comprises an email message.

Preferably, the delivery action comprises forwarding the message.

Preferably, the delivery action comprises permanently withholding the message.

Preferably, the delivery action comprises temporarily holding the message.

Preferably, the delivery action comprises temporarily holding the message until a predetermined delivery time.

Preferably, the delivery action comprises temporarily holding the message until a predetermined delivery time window.

Preferably, the delivery action comprises diverting the message to a predetermined forwarding address.

Preferably, the message delivery action component uses a policy that associates the user identity with a delivery rule applicable to a predetermined content category, to take the delivery action.

Preferably, the delivery rule comprises the predetermined delivery time.

Preferably, delivery rule comprises the predetermined delivery time window.

Preferably, the delivery rule comprises the predetermined message forwarding address.

Preferably, the system further comprises a policy database comprising a plurality of policies.

Preferably, the plurality of policies are organised by groups of users.

Preferably, the content categoriser component uses a domain to determine the content category of the message.

Preferably, the domain comprises a domain of the sending address of the message.

Preferably, the domain comprises a domain embedded in a body of the message.

Preferably, the content categoriser component examines a web page associated with the domain to determine the content category of the message.

Preferably, the content categoriser component uses a domain database comprising records of domains with associated predetermined content categories to determine the content category of the message.

Preferably, the content categoriser component examines the content of the message if the domain is not found in the domain database.

Preferably, the content categoriser component examines content of the message to determine the content category of the message.

Preferably, the system further comprises an action recording component that records delivery actions that have been taken in a logging database.

According to a second aspect of the present invention there is provided a method of processing a message, the method comprising the steps:
receiving the message;
determining a user identity from the message;
determining a content category of the message; and
taking a delivery action based on the determined user identity and the determined content category.

Preferably, the message comprises an incoming message and the user identity comprises an recipient user identity.

Alternatively, the message comprises an outgoing message and the user identity comprises a sender user identity.

Preferably, the message comprises an email message.

Preferably, the delivery action comprises forwarding the message.

Preferably, the delivery action comprises permanently withholding the message.

Preferably, the delivery action comprises temporarily holding the message.

Preferably, the delivery action comprises temporarily holding the message until a predetermined delivery time.

Preferably, the delivery action comprises temporarily holding the message until a predetermined delivery time window.

Preferably, the delivery action comprises diverting the message to a predetermined forwarding address.

Preferably, the message delivery action component uses a policy that associates the user identity with a delivery rule applicable to a predetermined content category, to take the delivery action.

Preferably, the delivery rule comprises the predetermined delivery time.

Preferably, the delivery rule comprises the predetermined delivery time window.

Preferably, the delivery rule comprises the predetermined message forwarding address.

Preferably, the step of determining a content category comprises the step of using a domain to determine the content category of the message.

Preferably, the domain comprises a domain of the sending address of the message.

Preferably, the domain comprises a domain embedded in a body of the message.

Preferably, the step of determining a content category comprises the step of examining a web page associated with the domain.

Preferably, the step of determining a content category comprises the step of using a domain database comprising records of domains with associated predetermined content categories.

Preferably, the step of determining a content category comprises the step of examining the content of the message if the domain is not found in the domain database.

Preferably, the step of determining a content category comprises the step of examining the content of the message.

Preferably, the method further comprises the step of recording delivery actions that have been taken in a logging database.

A computer readable medium having a computer program stored thereon, which when executed by a computer performs the method according to the second aspect.

The present invention will now be described by way of example only with reference to the accompanying figures in which;

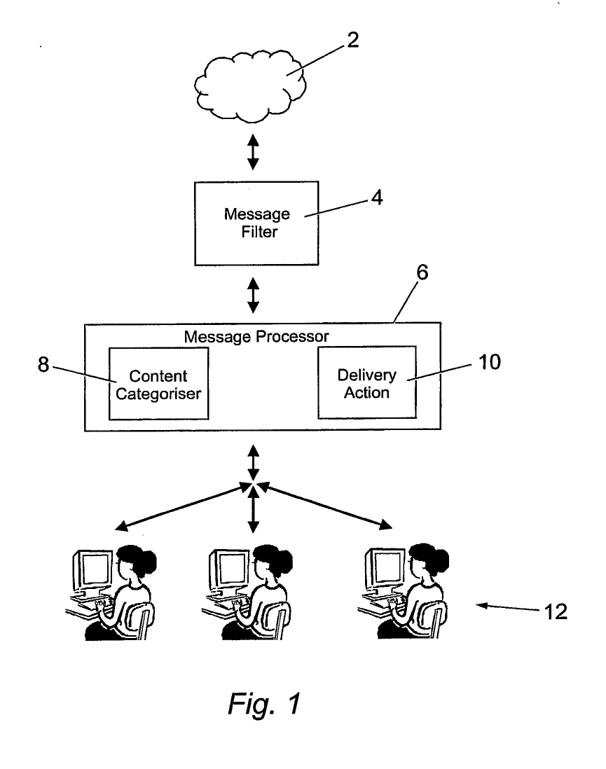

FIG. 1 illustrates, in schematic form email processing including the system in accordance with the present invention;

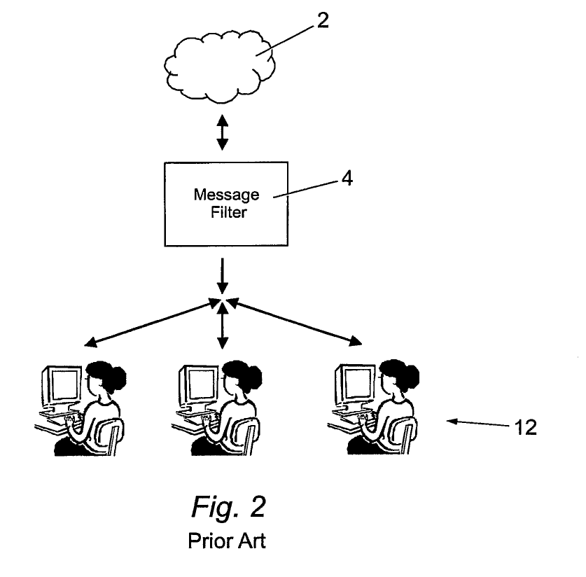

FIG. 2 illustrates in schematic form prior art email processing;

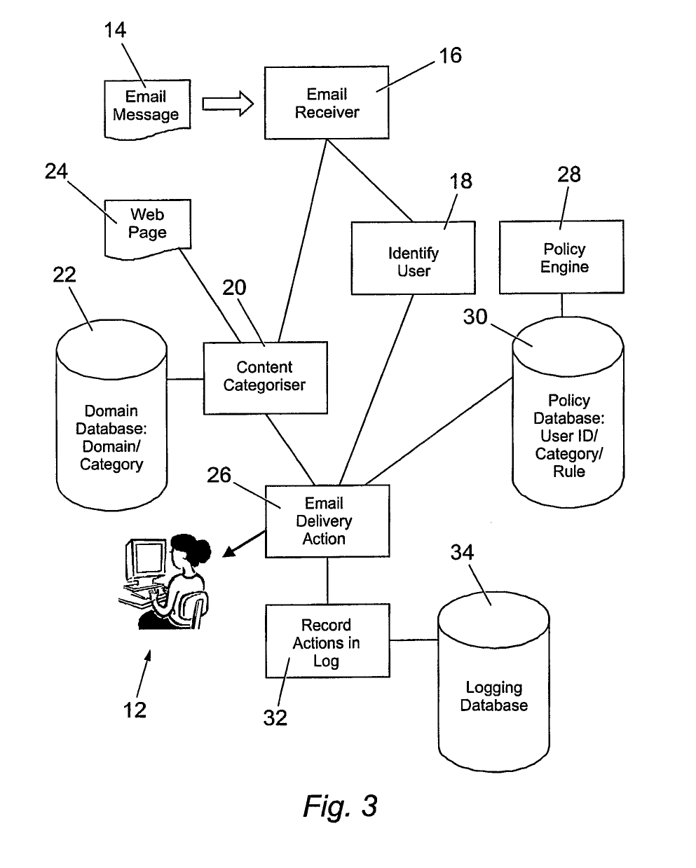

FIG. 3 illustrates in schematic form a preferred embodiment of the present invention;

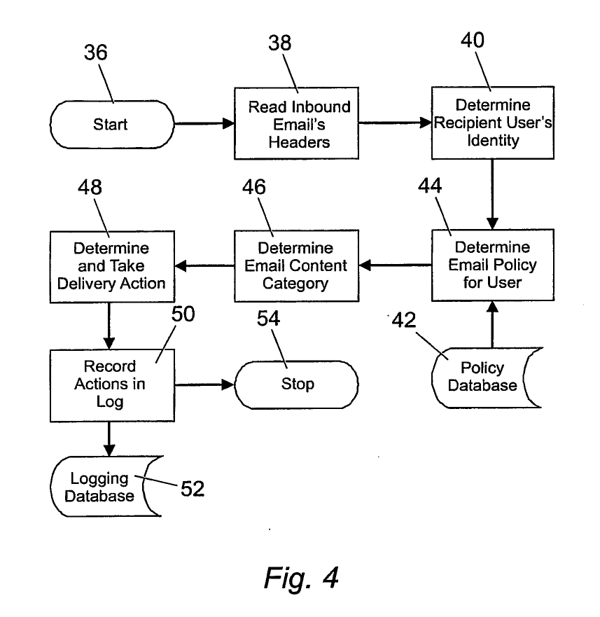

FIG. 4 illustrates a flow chart of an embodiment of a method of incoming message processing according to the present invention; and

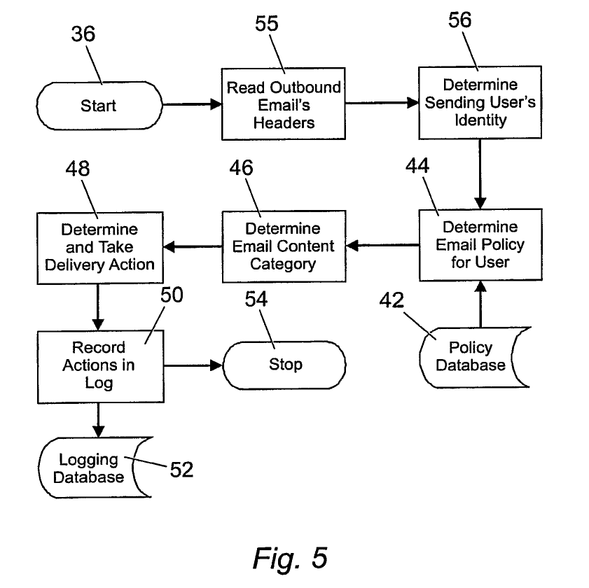

FIG. 5 illustrates a flow chart of an embodiment of a method of outgoing message processing according to the present invention.

The preferred embodiment of the present invention is an email processing system that may be used, along with conventional email filtering to remove malicious email, that functions to process incoming email messages appropriately. Although embodiments of the invention described below relate to email processing the invention is applicable to other forms of messages, for example; instant messages, voice messages, text messages etc.

With reference to FIG. 1, messages originating with a message sender travel through the internet 2 to the message filter 4 within an organisation. The message filter could be a stand-alone server running message filtering software, for example email filtering software. Alternatively, the message filter could be a software process running on a server or a distributed group of computers.

The message processor 6 comprises a content categorising component 8 and a delivery action component 10. The preferred embodiment of the present invention is to provide the message processor 6 as a stand alone server appliance which accepts a stream of email messages as at input and outputs a stream of process messages. However, as with the message filter 4, the system and method of the present invention could be implemented in a variety of ways across different computer systems or even integrated into the same computer systems as the message filter 4.

The messages are distributed to the recipient users 12.

Because the volume of malicious email generated on the internet shows no sign of decreasing, when considering where to add the extra layer of email processing provided by the present invention, it is preferable to place the additional processing of the present invention after the malicious content has already been removed by the message filter 4. This reduces the load placed on the message processing system of the present invention.

With reference to FIG. 2 a prior art message filter is shown with the numbering labelled as in FIG. 1. The system as shown in FIG. 2 has the disadvantage that messages are delivered immediately to the users, or their mail boxes, as soon as they have been processed by the message filter 4.

With reference to FIG. 3, an email message 14 is received by the email receiver 16. As mentioned above, the email message 14 will generally have been filtered by a conventional email filter. The system has a recipient identifier 18 that determines a recipient user identity from the received email message. The recipient would typically be identified from an email by reading the email header and extracting the destination email address. Although a recipient user identity is being used to refer to an email address, the recipient user identity might be a mailbox, distribution group, alias or another form of identifier of a destination.

In parallel or in sequence with the identifying of the recipient, the content categoriser 20 determines a content category of the email message. The content categoriser may use the domain of the sending address of the email message obtained from the email receiver 16 or by examining the email header itself. The content categoriser 20 may use other domains embedded in the header, for example the reply-to address, or a domain embedded in the message body in the form of a web address or email address to determine the content category of the database. A convenient way to use the domain to determine the content category is for the content categoriser to use a domain database 22 that comprises records of domains with associated predetermined content categories. This is a database of known domains from which email originates. Each domain can be associated with zero, one or more content categories that characterise that type of content the typically originates from the respected domain. These content categories define the types of email content that the end user may receive. Thus the content categories in the database model the primary purpose of the origination domain. Some example domains and their associated categories are listed below.

Ebay.com—auction

Autotrader.co.uk—automotive

Gmail.com—webmail

Monster.com—recruitment

Glasgow.ac.uk—education

Wikipedia.org—reference

Bbc.co.uk—arts and entertainment

Willhill.co.uk—gambling

Celticfc.net—sports

Bible.com—religion

By examining the domain of the sending email address, or other email addresses or other fields containing domains (e.g. a web page url) within the headers or body of the message, then consulting the database 22 of known domains and their associated categories, the content categoriser may determine content category of the email message. If the email address originates from a domain unknown to the database, that is if the domain of the sending address of the email address is not found in the database, then an attempt may be made to surmise the category from the title and body text contained within the email message. In this way the content categoriser examines the content of the email message to determine the content category of the email message.

If insufficient information is available in the email itself, then the main web page 24 associated with the domain (or one or more other pages) can be examined by the content categoriser or another component to determine the content category of the email message. Although in the example above the content category is determined starting with domain look up then looking at the email message itself and finally the web page, it would also be possible to use all three of those methods of determining the content category in a different order or combination, or altogether. Other methods of determining content category can be envisaged including, but not limited to, analysis of the time of day that the email message is received, frequency of which similar emails are received, etc.

The email delivery action component 26 takes a delivery action based on the determined recipient user identity and the determined content category. In this embodiment of the present invention the policy engine 28 is used for the configuration and storage in a policy database 30 of email processing policy. The policy engine contains information such as: aggregation of users into groups; the delivery actions applicable for different categories across the defined users in groups; and the times of day of which different delivery actions are applicable. In this way the email delivery action component uses policies that associate the recipient user identity with delivery rules applicable to predetermined content categories, in order to take the delivery action. The delivery rules may comprise predetermined delivery times, predetermined delivery time windows, periods of working and non-working time, predetermined email forwarding addresses to which messages should be send or other rules. Thus the surmised content category is used to retrieve a delivery action rule from the email policy previously defined for the recipient user in question. The delivery actions include but are not limited to
1. Deliver: forward the email to the user.
2. Block: withhold the email permanently.
3. Hold: withhold the email temporarily until the time deemed suitable by the email policy defined for that user and then forward the email to the user.
4. Divert: forward the email to another email address, defined within the policy. This action may be combined with any of the 3 previously defined actions.
5. Truncate: remove attachments before forwarding.

In particular the hold delivery action, which provides the temporary withholding of an email from delivery until deemed suitable, allows an organisation to ensure that, except for explicitly defined intervals, its staff will only receive emails that are applicable to the delivery of the goals of the business. Those emails which are deemed to be unproductive can be delivered at times which are set aside for users' own purposes such as meal breaks or pre/post work periods.

Optionally, the system has a delivery action recorder component 32 that writes entries to a logging database 34 that stores a time stamp, all the relevant information stored in the emails' headers, the delivery action taken and the reason why that action was taken. The entire body of each email may be stored in the logging database.

With reference to FIG. 4 the process used for an individual email may be as follows. At the start 36 an inbound email address's headers are read 38. This step extracts the information such as the sender and destination email addresses, the email subject and the time that the email was sent.

The recipient user's identity or identifier is determined 40. Email policy may be tailorable for different users. Determining the recipient's identity based on the destination email address is used to determine the policy actions to be applied to each email. Once a user's identity has been determined, then the policy database 42 is consulted in order to obtain the policy that applies to the identified recipient user 44.

Next the email content category is determined 46. This is done as described in relation to FIG. 3 above. Next the delivery action is determined and taken 48 also as described above. Finally, the actions taken are recorded 50 in a logging database 52 at which point the processing of the email is complete 54. The email is then treated by the conventional email distribution systems and would typically end up in the inbox of the recipient user.

Messaging, such as email, is often a conversation. Processing incoming message according to the present invention deals with one side of the conversation, where the determined user identity is a recipient of the message. The productivity benefits are applicable in the outbound direction as for inbound email.

With reference to FIG. 5, the present invention may also be used to deal with the other side of the conversation, by processing outgoing messages, where the determined user identity is a sender of the message. The steps in FIG. 5 are the same as in FIG. 4, except an outbound email address's headers are read 55. This step again extracts the information such as the sender and destination email addresses, the email subject and the time that the email was sent. The sending user's identity or identifier is then determined 56, then the policy database 42 is consulted in order to obtain the policy that applies to the identified sending user 44.

Further modifications and improvements may be added without departing from the scope of the invention described by the claims herein.

1. A message processing system comprising:
a message receiver component that receives a message;
an identifying component that determines a user identity from the message;
a content categoriser component that determines a content category of the message; and
a message delivery action component that takes a delivery action based on the determined user identity and the determined content category.

2. The message processing system of claim 1, wherein the message comprises an incoming message and the user identity comprises a recipient user identity.

3. The message processing system of claim 1, wherein the message comprises an outgoing message and the user identity comprises a sender user identity.

4. The message processing system of claim 1, wherein the message comprises an email message.

5. The message processing system of claim 1, wherein the delivery action comprises forwarding the message.

6. The message processing system of claim 1, wherein the delivery action comprises permanently withholding the message.

7. The message processing system of claim 1, wherein the delivery action comprises temporarily holding the message.

8. The message processing system of claim 1, wherein the delivery action comprises temporarily holding the message until a predetermined delivery time.

9. The message processing system of claim 1, wherein the delivery action comprises temporarily holding the message until a predetermined delivery time window.

10. The message processing system of claim 1, wherein the delivery action comprises diverting the message to a predetermined forwarding address.

11. The message processing system of claim 1, wherein the message delivery action component uses a policy that associates the user identity with a delivery rule applicable to a predetermined content category to take the delivery action.

12. The message processing system of claim 11, wherein the delivery action comprises temporarily holding the message until a predetermined delivery time and the delivery rule comprises the predetermined delivery time.

13. The message processing system of claim 11, wherein the delivery action comprises temporarily holding the message until a predetermined delivery time window and the delivery rule comprises the predetermined delivery time window.

14. The message processing system of claim 11, wherein the delivery action comprises diverting the message to a predetermined forwarding address and the delivery rule comprises the predetermined message forwarding address.

15. The message processing system of claim 1 further comprising a policy database comprising a plurality of policies.

16. The message processing system of claim 15, wherein the plurality of policies are organised by groups of users.

17. The message processing system of claim 1, wherein the content categoriser component uses a domain to determine the content category of the message.

18. The message processing system of claim 17, wherein the domain comprises a domain of the sending address of the message.

19. The message processing system of claim 17, wherein the domain comprises a domain embedded in a body of the message.

20. The message processing system of claim 17, wherein the content categoriser component examines a web page associated with the domain to determine the content category of the message.

21. The message processing system of claim 1, wherein the content categoriser component uses a domain database comprising records of domains with associated predetermined content categories to determine the content category of the message.

22. The message processing system of claim 17, wherein the content categoriser component examines the content of the message if the domain is not found in the domain database.

23. The message processing system of claim 1, wherein the content categoriser component examines content of the message to determine the content category of the message.

24. The message processing system of claim 1, further comprising an action recording component that records delivery actions that have been taken in a logging database.

25. A method of processing a message, the method comprising the steps:
receiving the message;
determining a user identity from the message;
determining a content category of the message; and
taking a delivery action based on the determined user identity and the determined content category.

26. The method of claim 25, wherein the message comprises an incoming message and the user identity comprises an recipient user identity.

27. The method of claim 25, wherein the message comprises an outgoing message and the user identity comprises a sender user identity.

28. The method of claim 25, wherein the message comprises an email message.

29. The method of claim 25, wherein the delivery action comprises forwarding the message.

30. The method of claim 25, wherein the delivery action comprises permanently withholding the message.

31. The method of claim 25, wherein the delivery action comprises temporarily holding the message.

32. The method of claim 25, wherein the delivery action comprises temporarily holding the message until a predetermined delivery time.

33. The method of claim 25, wherein the delivery action comprises temporarily holding the message until a predetermined delivery time window.

34. The method of claim 25, wherein the delivery action comprises diverting the message to a predetermined forwarding address.

35. The method of claim 25, wherein the message delivery action component uses a policy that associates the user identity with a delivery rule applicable to a predetermined content category, to take the delivery action.

36. The method of claim 35, wherein the delivery action comprises temporarily holding the message until a predetermined delivery time and the delivery rule comprises the predetermined delivery time.

37. The method of claim 35, wherein the delivery action comprises temporarily holding the message until a predetermined delivery time window and the delivery rule comprises the predetermined delivery time window.

38. The method of claim 35, wherein the delivery action comprises diverting the message to a predetermined forwarding address and the delivery rule comprises the predetermined message forwarding address.

39. The method of claim 25, wherein the step of determining a content category comprises the step of using a domain to determine the content category of the message.

40. The method of claim 39, wherein the domain comprises a domain of the sending address of the message.

41. The method of claim 39, wherein the domain comprises a domain embedded in a body of the message.

42. The method of claim 39, wherein the step of determining a content category comprises the step of examining a web page associated with the domain.

43. The method of claim 25, wherein the step of determining a content category comprises the step of using a domain database comprising records of domains with associated predetermined content categories.

44. The method of claim 43, wherein the step of determining a content category comprises the step of examining the content of the message if the domain is not found in the domain database.

45. The method of claim 25, wherein the step of determining a content category comprises the step of examining the content of the message.

46. The method of claim 25, further comprising the step of recording delivery actions that have been taken in a logging database.

47. A computer readable medium having a computer program stored thereon, which when executed by a computer performs the method of claim 25.
